(19) United States
(12) Patent Application Publication
(10) Pub. No.: US 2005/0214708 A1
(43) Pub. Date: Sep. 29, 2005

(54) Orthodontic device, particularly orthodontic coupling

(75) Inventor: Giuseppe Antignano, Rocca D'Evandro (CE) (IT)

Correspondence Address: YOUNG & THOMPSON, 745 SOUTH 23RD STREET, 2ND FLOOR, ARLINGTON, VA, 22202, US

(73) Assignee: ORTHODONTIC MANUFACTURER SIA S.R.L, ROCCA D'EVANDRO (CE) (IT)

(21) Appl. No.: 11/080,504

(22) Filed: Mar. 16, 2005

(30) Foreign Application Priority Data
Mar. 19, 2004 (IT) RM2004A000140

(51) Int. Cl. A61C 3/00

(52) U.S. Cl. 433/9

(57) ABSTRACT

An orthodontic device (1), has a base (B) and a body (C), and at least two concentric closed lines (4, 5) on the base (B).

The present invention concerns an improved orthodontic device, particularly orthodontic coupling.

More specifically, the invention concerns an orthodontic coupling or any other kind to be glued on teeth, allowing to obtain a higher adhesion on the tooth and thus a lower possibility of disjunction of coupling from the same tooth, in case coupling or device is subjected to ending or torsion stress.

As it is well known, in last decades fixed orthodontia is always more diffused, particularly, but not only, for adolescents.

Said diffusion has determined the realisation of many solutions relevant to orthodontic couplings, i.e. those elements applied on the teeth, and having a structure allowing the fixing of the orthodontic wire according to the orthodontist decisions.

Usually, orthodontic couplings have a base, coupled on the tooth by suitable adhesives, and a body, having a slot through which the orthodontic wire can pass.

Many solutions have been suggested in the past years, many of them addressed to provide a better fixing to the tooth base, being it necessary avoiding that a premature disjunction can occur, and to create a body resisting in an optimum way to the stresses to which it is subjected during the usual life of the patient.

Other solutions have been suggested in order to improve the aesthetic aspect of the orthodontic apparatus.

In this contest is included the solution according to the present invention, suggesting an improved orthodontic device allowing to obtain better resistance performances with respect to torsion and bending stresses, and thus lower possibility of disjunction.

It is therefore specific object of the present invention an orthodontic device, particularly orthodontic coupling, having a base and a body, at least two concentric closed lines being realised on said base.

Preferably, according to the invention, said concentric lines are realised in bas-relief o high relief with respect to the body plane.

Particularly, it can be provided a closed concentric line in high relief and a closed concentric line in bas-relief.

Still according to the invention, said orthodontic device provides a number higher than two of closed concentric lines.

Always according to the invention, said concentric lines are circular lines, elliptic lines, or closed lines having different shape.

Furthermore, according to the invention, it is provided a net, or other kind of appendix, above said concentric lines realised on the base, said appendix being or not provided with undercut.

Further, according to the invention, said closed concentric lines can be rough.

The device according to the invention can be comprised of metallic material, metallic alloy, plastic material, ceramic material, etc.

The present invention will be now described, for illustrative but not limitative purposes, according to its preferred embodiments, with particular reference to the figures of the enclosed drawings, wherein:

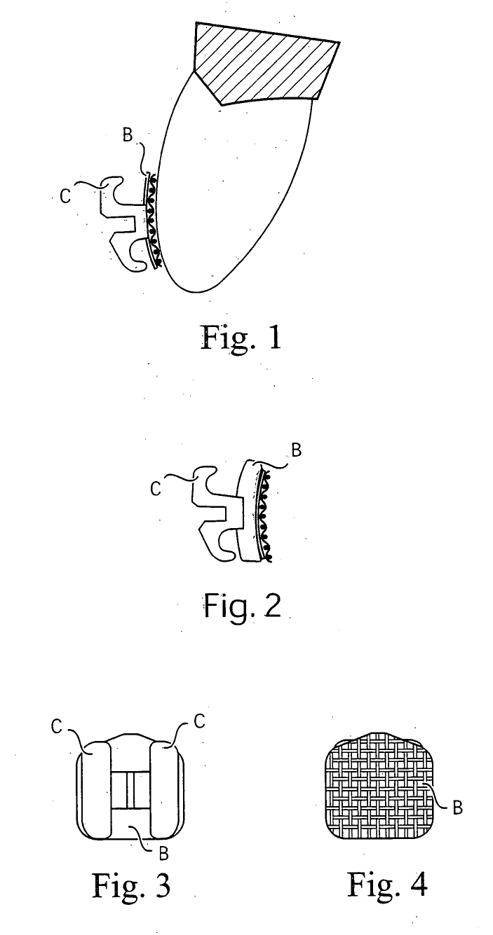

FIG. 1 is a section view of a standard orthodontic coupling in a use position;

FIG. 2 is a lateral view of the orthodontic coupling of FIG. 1;

FIG. 3 is a top view of the orthodontic coupling of FIG. 1;

FIG. 4 is a bottom view of the orthodontic coupling of FIG. 1, thus showing its front face;

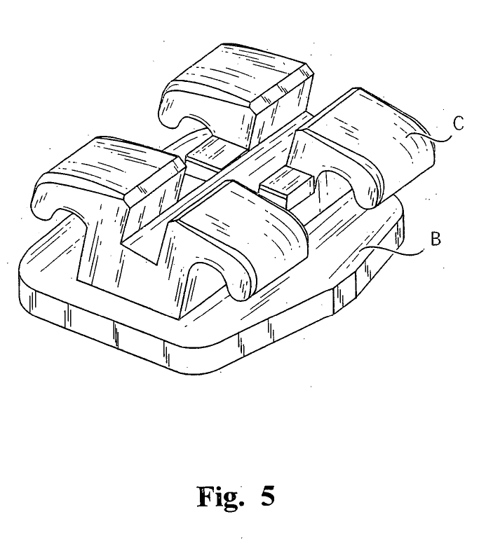

FIG. 5 is a perspective view of the orthodontic coupling of FIG. 1;

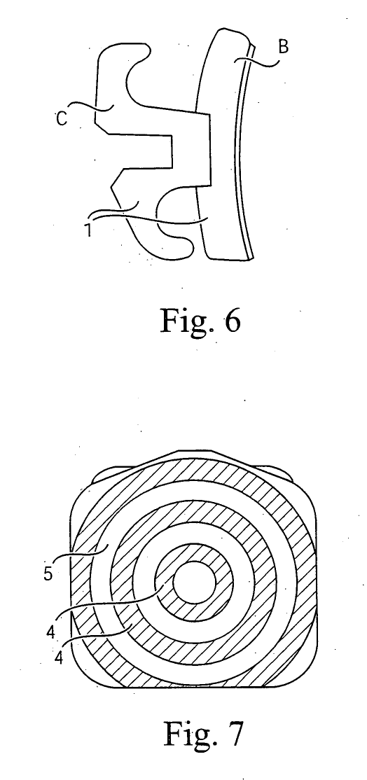

FIG. 6 is a lateral view of an orthodontic coupling according to the invention; and

FIG. 7 is a bottom view of the orthodontic coupling of FIG. 6, thus showing its front face.

Coming now to observe FIGS. 6 and 7 of the enclosed drawings, it is shown an embodiment of the orthodontic coupling according to the present invention, generically indicated by reference number 1, having a base B and a body C.

From FIG. 7 it is possible observing that a plurality of closed lines 4 and 5 is provided on base B, said lines being realised in high relief or bas-relief.

As already said, said lines 4, 5 can have any thickness or depth on the surface that will contact the tooth.

Orthodontic coupling 1 according to the invention will have a higher resistance to the torsion stresses, and by suction cup effect, will better react to the simple and deviated bending stresses, thus permitting a better adhesion of the adhesive provided on base B of coupling 1, thus reducing possibilities of disjunction of coupling 1 from tooth.

As already described, retention is obtained by closed concentric lines 4, 5, that must not be necessarily circular or elliptic lines. They are realised in high relief or bas-relief, and it is possible placing a net, or another appendix, with or without undercut. It is further possible providing a surface roughness.

Application can occur on every kind of orthodontic fitting to be temporarily or permanently glued on teeth for orthodontic treatment, comprised of metallic material, metallic alloy, plastic material, ceramic material, zirconium, composite material, etc.

The present invention has been described for illustrative but not limitative purposes, according to its preferred embodiments, but it is to be understood that modifications and/or changes can be introduced by those skilled in the art without departing from the relevant scope as defined in the enclosed claims.

1. Orthodontic device, particularly orthodontic coupling, having a base and a body, characterised in that at least two concentric closed lines are realised on said base.

2. Orthodontic device according to claim 1, characterised in that said concentric lines are realised in bas-relief o high relief with respect to the body plane.

3. Orthodontic device according to claim 1, characterised in that a closed concentric line is realised in high relief and a closed concentric line is realised in bas-relief.

4. Orthodontic device according to claim 1, characterised in that said orthodontic device provides a number higher than two of closed concentric lines.

5. Orthodontic device according to claim 1, characterised in that said concentric lines are circular lines, elliptic lines, or closed lines having different shape.

6. Orthodontic device according to claim 1, characterised in that it is provided a net, or other kind of appendix, above said concentric lines realised on the base.

7. Orthodontic device according to claim 6, characterised in that said appendix being or not provided with undercut.

8. Orthodontic device according to claim 1, characterised in that said closed concentric lines are rough.

9. Orthodontic device according to claim 1, characterised in that it is comprised of metallic material, metallic alloy, plastic material, ceramic material, etc.

10. (cancel)
